(19) United States
(12) Patent Application Publication
(10) Pub. No.: US 2006/0022551 A1
(43) Pub. Date: Feb. 2, 2006

(54) Stator for electrical motor

(75) Inventors: Chin-Long Ku, Tu-Cheng (TW); Chin-Wen Yeh, Tu-Cheng (TW); Chia-Mou Liu, Tu-Cheng (TW)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: Foxconn Technology Co., Ltd., Tu-Cheng City (TW)

(21) Appl. No.: 11/135,572

(22) Filed: May 23, 2005

(30) Foreign Application Priority Data
Jul. 30, 2004 (CN) 200410050976.6

(51) Int. Cl. H02K 1/00; H02K 1/12; H02K 19/26; H02K 23/40

(52) U.S. Cl. 310/254; 310/194

(57) ABSTRACT

A stator (1) includes a stator core (10), an insulating member (14) attached to the stator core, and a printed circuit board (18) attached to the insulating member. The stator core includes a center portion (102). Pole members (104) extend outwardly from the center portion. The insulating member includes a center section (142) corresponding to the center portion of the stator core. Extensions (14) extend outwardly from the center portion of the insulating member, corresponding to the pole members. The insulating member defines an outer periphery. Joint portions of the insulating member and the printed circuit board are located within the outer periphery of the insulating member and spaced from the extensions a distance along an axial direction of the stator.

### TECHNICAL FEILD

The present invention relates generally to electrical motors, and more particularly to a stator of such a motor.

### BACKGROUND

Electrical motors have been widely used to transfer electrical energy to mechanical energy in a form of rotational motion. For example, in a heat-dissipating fan, an electrical motor is used to drive fan blades to rotate therewith, thereby generating airflow toward heat-generating components.

The electrical motor usually includes a stator and a rotor rotatable with respect to the stator. Referring to FIG. 4, such a stator 1′ typically includes a stator core 10′ with upper and lower insulating frames 12′, 14′ located at opposite sides of the stator core 1′. A round PCB (printed circuit board) 18′ is attached to the lower insulating frame 14′.

To attach the PCB 18′ to the lower insulating frame 14′, the lower insulating frame 14′ forms a plurality of flanges 142′ extending downwardly from an outer periphery thereof toward the PCB 18′, and the PCB 18′ is attached to free ends of the flanges 142′.

In accordance with this design, the PCB 18′ has a diameter larger than that of the lower insulating frame 14′ and is attached to the lower insulating frame at a position adjacent to the outer periphery thereof. However, such a design is generally not desirable in the industry for some reasons. For example, the large size of the PCB 18′ reflects high material cost. In addition, the motor itself generates heat during operation and therefore needs heat dissipation. The PCB 18′ of large size which is attached to the lower insulating member at an outer periphery thereof may retard ventilation inside the motor, which in turn depresses the heat dissipation effectiveness of the motor. Therefore, a heretofore unaddressed need exists in the industry to address the aforementioned deficiencies and inadequacies.

### SUMMARY OF THE INVENTION

The present invention provides a stator for an electrical motor. The stator comprises a stator core, an insulating member attached to the stator core, and a printed circuit board attached to the insulating member. The stator core comprises a center portion and a plurality of pole members extending outwardly from the center portion. The insulating member comprises a center section corresponding to the center portion of the stator core, and a plurality of extensions extending outwardly from the center section and corresponding to the pole members. The insulating member defines an outer periphery. Joint portions of the insulating member and the printed circuit board are located within the outer periphery of the insulating member, and spaced from the extensions of the insulating member a distance along an axial direction of the stator, thereby improving the ventilation effectiveness of the stator and thus the motor.

Other systems, methods, features and advantages of the present invention will be drawn from the following detailed description of the preferred embodiments of the present invention with attached drawings, in which:

### BRIEF DESCRIPTION OF THE DRAWINGS

FIG. 1 is an isometric, exploded view of a stator according to a preferred embodiment of the present invention;

FIG. 2 is similar to FIG. 1, but viewed from another aspect;

FIG. 3 is an assembled view of the stator of FIG. 1; and

FIG. 4 is an isometric, exploded view of a conventional stator.

### DESCRIPTION OF PREFERRED EMBODIMENTS

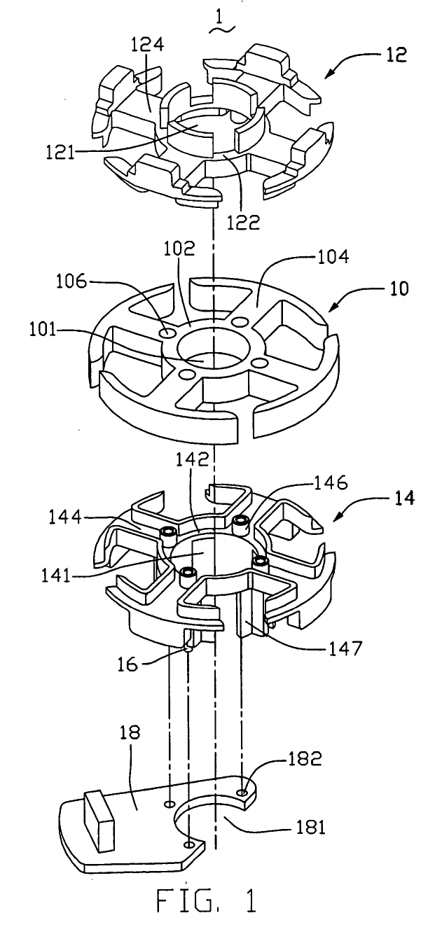

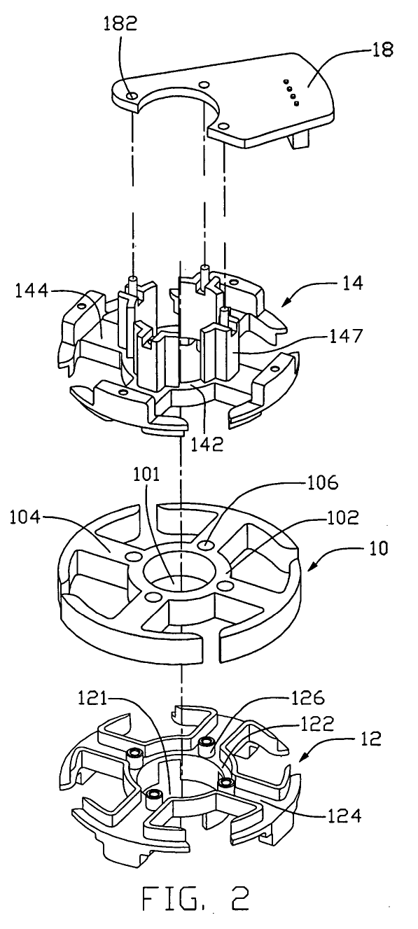

FIGS. 1 and 2 show a stator 1 of a motor in accordance with a preferred embodiment of the present invention. The stator 1 comprises a stator core 10, upper and lower insulating frames 12, 14 for being attached to top and bottom sides of the stator core 10 respectively, and a PCB 18 (Printed Circuit Board) for being attached to the lower insulating frame 14. For the sake of simplicity, the stator coils of the stator 1 are omitted.

The stator core 10 may comprise a plurality of laminated silicon steel sheets. The stator core 10 comprises a center portion 102, and four generally T-shaped pole members 104 extending radially and outwardly from the center portion 102. Alternatively, the stator core 10 may form more than or less than four pole members 104 according to practical needs. The center portion 102 defines an inner bore 101 therein. Four positioning holes 108 are defined through the stator core 10 at junctions of the center portion 102 and the pole members 104 thereof.

The upper insulating frame 12 comprises a center section 122 corresponding to the center portion 102 of the stator core 10, and four generally T-shaped extensions 124 formed around the center section 122 corresponding to the pole members 104 of the stator core 10 respectively. The center section 122 of the upper insulating frame 12 defines therein an inner bore 121, corresponding to the inner bore 101 of the center portion 102 of the stator core 10.

As can be better seen in FIG. 2, four positioning protrusions 126 are formed on a bottom surface of the upper insulating frame 12, for extending into the positioning holes 106 of the stator core 10 respectively when the upper insulating frame 12 is attached to a top side of the stator core 10.

The lower insulating frame 14 also has a center section 142 and four generally T-shaped extensions 144 formed around the center section 142. The lower insulating frame 14 forms four positioning protrusions 146, for extending into the positioning holes 106 of the stator core 10 when the lower insulating frame 14 is attached to a bottom side of the stator core 10.

The lower insulating frame 14 comprises four legs 147 extending downwardly from the center section 142, for mounting of the PCB 18 to the stator 1. The legs 147 are equidistantly spaced from each other and extend in a direction opposite to the stator core 10. The PCB 18 is to be attached to free ends of three of the legs 147. The PCB 18 defines a cutout 181 corresponding to the inner bores 101, 121 of the stator core 10 and the upper insulating frame 12 and an inner bore 141 of the lower insulating frame 14.

In the preferred embodiment, the four legs 147 are formed at junctions of the center section 142 and the extensions 144 and around the inner bore 141. Three of the legs 147 each comprise a mounting pin 16 formed at the free end thereof. Correspondingly, the PCB 18 defines three mounting holes 182 for receiving the mounting pins 16 respectively, thereby attaching PCB 18 to the legs 147. In alternative embodiments, there may form more legs 147 on the center section 142. In addition, more mounting pins 16 may be formed at the free ends of the legs 147 for attachment of the PCB 18.

The mounting pins 16 may be integrally formed with the legs 147 by molding. Alternatively, the legs 147 may form holes at the free ends thereof to engagingly receive the mounting pins 16 therein.

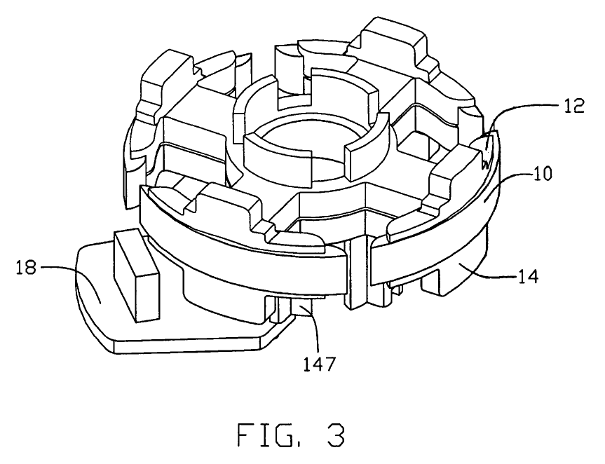

Referring also to FIG. 3, in assembly of the stator 1, the upper insulating frame 12 is placed upon the top side of the stator core 10, with the positioning protrusions 126 aligned with the positioning holes 106 of the stator core 10 respectively. The upper insulating frame 12 is then pressed against the stator core 10, so that the positioning protrusions 126 are engagingly received in the positioning holes 106 respectively. The upper insulating frame 12 is thus assembled to the top side of the stator core 10.

Substantially in the same manner, the lower insulating frame 14 is assembled to the bottom side of the stator core 10, with the positioning protrusions 146 engagingly received in the positioning holes 106.

Finally, the mounting pins 16 of the lower insulating frame 14 are engaged into three mounting holes 180 of the PCB 18 to attach the PCB 18 to the lower insulating frame 14. When the stator 1 is fully assembled, the inner bore 101 of the stator core 10, the inner bores 121, 141 of the upper and lower insulating frames 12, 14, and the cutout 181 of the PCB 18 are aligned with each other. The inner bores 101, 121, 141, and the cutout 181 are for extension therethrough of a bearing support (not shown) of the motor.

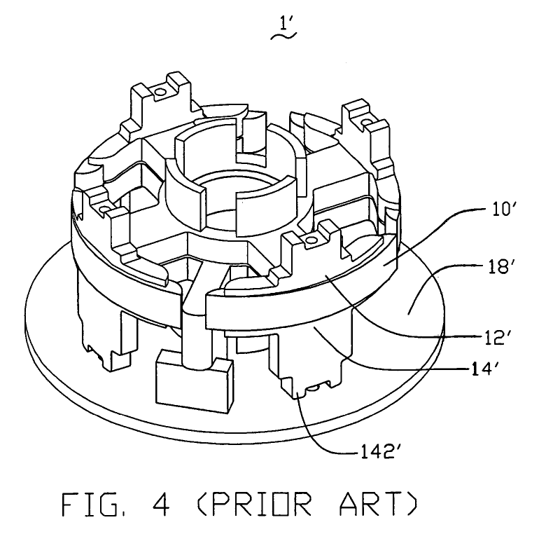

In the stator 1 of the preferred embodiment of the present invention, the PCB 18 is attached to the free ends of the legs 147 of the lower insulating frame 14, and the legs 147 are formed on the center section 142 of the lower insulating frame 14. When viewed from the PCB 18 to the lower insulating fame 14, the joint portions of the lower insulating frame 14 and the PCB 18 are located at a position which is beneath the center section 142 of the lower insulating frame 14, around the bore 141 of the lower insulating frame 14, inside an outer periphery of the lower insulating frame 14, and spaced from the extensions 144 a distance along an axial direction of the stator 1. Therefore, the PCB 18 can be designed to have a smaller size, in comparison with the PCB 18′ attached to the outer periphery of the lower insulating frame 14′ as shown in FIG. 4. This can not only reduce the cost of the PCB 18, but also improve the ventilation inside the motor to obtain a good heat dissipation effectiveness of the motor.

In the preferred embodiment of the present invention, the legs 147 are formed at the junctions of the center section 142 and the extensions 144. Alternatively, the legs 147 may be located at other positions around the center section 142. For example, the legs may be formed on the center portion 142 between adjacent extensions 144.

It is understood that the invention may be embodied in other forms without departing from the spirit thereof. The above-described examples and embodiments are to be considered in all respects as illustrative and not restrictive, and the invention is not to be limited to the details given above.

We claim:

1. A stator for an electrical motor, comprising:
a stator core comprising a center portion, and a plurality of pole members extending outwardly from the center portion;
a first insulating frame located at a first side of the stator core;
a second insulating frame located at an opposite second side of the stator core, the second insulating frame comprising a center section with a plurality of extensions extending from the center section;
a plurality of legs extending perpendicularly from the center section in a direction opposite to the stator core; and
a printed circuit board attached to the legs.

2. The stator of claim 1, wherein the legs are formed at junctions of the center section and the extensions.

3. The stator of claim 1, wherein the legs comprise a plurality of mounting pins at free ends thereof, and the printed circuit board defines corresponding mounting holes receiving the mounting pins therein.

4. The stator of claim 1, wherein the stator core defines a plurality of positioning holes therein, and the first and second insulating frames form a plurality of positioning protrusions extending into the positioning holes.

5. The stator of claim 4, wherein the positioning holes are defined around the center portion of the stator core.

6. A stator for an electrical motor, comprising:
a stator core comprising a center portion and a plurality of pole members extending outwardly from the center portion;
an insulating member attached to the stator core, comprising a center section corresponding to the center portion of the stator core, and a plurality of extensions extending outwardly from the center section and corresponding to the pole members, the insulating member defining an outer periphery; and
a printed circuit board engaged with the insulating member, joint portions of the insulating member and the printed circuit board being spaced from said outer periphery a distance along extending directions of the extensions.

7. The stator of claim 6, wherein said joint portions correspond to junctions of the center section and the extensions in a direction perpendicular to said extending directions.

8. The stator of claim 7, wherein the insulating member comprises a plurality of legs extending from said junctions, and the printed circuit board is attached to the legs.

9. The stator of claim 8, wherein the printed circuit board defines a plurality of mounting holes, and the legs at their free ends comprises a plurality of mounting pins received in the mounting holes.

10. A stator for an electrical motor, comprising:
a stator core;
a first insulating member attached to an upper side of the stator core;
a second insulating member attached to a bottom side of the stator core; and
a printed circuit board attached to the second insulating member at a position which is located inside an outer periphery of the second insulating member.

11. The stator of claim 10, wherein the position is around an inner bore of the lower insulating member, the inner bore being adapted for receiving a bearing support.

12. The stator of claim 11, wherein the second insulating member has a center section defining the inner bore, and a plurality of extensions extending radially outwardly from the center section, the position where the printed circuit board is attached to the lower insulating member is beneath the center section and spaced from the extensions along an axial direction of the stator.

13. The stator of claim 12, wherein the lower insulating member has a plurality of legs extending downwardly from the center section, and the position wherein the printed circuit board is attached to the lower insulating member is at free ends of the legs.

14. The stator of claim 13, wherein the free ends of the legs have mounting pins engaging in the printed circuit board.

15. The stator of claim 14, wherein the printed circuit board has three mounting holes receiving the mounting pins.

16. The stator of claim 15, wherein the lower insulating member has positioning protrusions formed on the center section and engaging in a center portion of the stator core.
